(19) United States
(12) Patent Application Publication
(10) Pub. No.: US 2020/0095480 A1
(43) Pub. Date: Mar. 26, 2020

(54) UV CURABLE CONDUCTIVE ADHESIVE

(71) Applicant: Tektronix, Inc., Beaverton, OR (US)

(72) Inventor: Julie A. Campbell, Beaverton, OR (US)

(73) Assignee: Tektronix, Inc., Beaverton, OR (US)

(21) Appl. No.: 16/570,941

(22) Filed: Sep. 13, 2019

Related U.S. Application Data
(60) Provisional application No. 62/734,235, filed on Sep. 20, 2018.

(51) Int. Cl. C09J 9/02; C09J 4/00; C09J 133/06

(52) U.S. Cl. CPC C09J 9/02; C09J 4/00; C09J 2205/31; C09J 133/066; C09J 133/064; C09J 133/06

(57) ABSTRACT

A composition of matter includes an ultraviolet (UV) and thermally curable, non-epoxy acrylic adhesive having a concentration in the range of 5 to 30 weight percent of the composition and conductive metal particles having a concentration in the range of 70 to 95 weight percent of the composition.

### RELATED APPLICATIONS

This application is a continuation of, and claims priority to, U.S. Provisional Patent Application No. 62/734,235, filed Sep. 20, 2018.

### FIELD

This disclosure relates to electrically-conductive, UV-curable adhesives, more particularly to those adhesives used for probes and other test and measurement instrumentation to devices under test.

### BACKGROUND

Electrically conductive adhesives may be used to create physical and electrical connections between conductive components. In particular, conductive adhesives may be used to attach a test and measurement probe to a device under test (DUT). Some conductive adhesives can be cured by applying ultraviolet (UV) light to the adhesive when it is in its soft or flowing state to harden the adhesive in place.

Some conventional UV-cure conductive adhesives are available on the market. However, these existing adhesives generally have an epoxy base. When testing the performance of these adhesives, the inventor discovered that conventional, epoxy-based adhesives do not stick well to some metals, including, significantly, gold and silver, which are common surface finishes in many DUTs. Therefore, the performance of these conventional adhesives has severe limitations in some applications.

Embodiments of the disclosed apparatus and methods address shortcomings in the prior art.

### DETAILED DESCRIPTION

The embodiments here include a UV and thermally curable conductive adhesive consisting of an acrylic-base adhesive, rather than an epoxy-base adhesive, and a quantity of metal particles to provide electrical conductivity. The adhesive may also contain an optional filler material, or thickening agent, to adjust the viscosity of the adhesive for different applications. For purposes of this discussion, the thickening agent, if added, will be considered part of the acrylic-base adhesive.

In this discussion, the combination of the acrylic-base adhesive and the metal flakes will be referred to as a “conductive adhesive,” “composition of matter,” or as a “UV-curable conductive adhesive.” The term “acrylic-base adhesive” or “acrylic adhesive” refers to the acrylic adhesive and any other components, but not including the metal flakes.

For example, the inventor has found a viscosity of approximately 15,000 centipoise (cP) to be good for a probe-to-DUT attachment performed by hand. But other applications such as, for example, screen printing on a printed circuit board (PCB) may use a thicker formulation having a viscosity of approximately 75,000 cP. In other embodiments, the ‘thinner’ viscosity may be in the range of 12,000 to 18,000 cP, and the ‘thicker’ version in the range of 72,000 to 78,000 cP. The thickening agent is considered part of the acrylic-base adhesive. Embodiments include both the thin acrylic-base (low viscosity) and thick acrylic-base (high viscosity) formulations of the conductive adhesive. These have been tested and work well, meaning that they stick to various metals, including gold and silver pads, and have adequate performance over elevated temperatures.

The disclosed technology also includes embodiments in which the amount of metal flake in the conductive adhesive is precisely adjusted to create a “controlled resistance” formulation of the conductive adhesive. When these formulations are used in a probe-to-DUT attach operation, the conductive adhesive itself can act as a resistor as close as physically possible to the test point on the DUT. This improves probing and measurement performance.

The resistance of this material is more properly referred to as the volume resistivity, also known as bulk resistivity or specific electrical resistivity. The units are typically expressed as Ohm-meters (Ω·m). This may be stated more completely as Ω·m²/m, or Ω˜area/length. When divided by the sheet thickness it may be expressed as Ω˜m(m/m)/m or just Ohms, Ω. Using lower amounts of metal flake as a weight percent in the formulation will increase the volume resistivity. Controlling the metal flake can produce resistivity of 0 Ohms, resistivity in the range of 20-1000 Ohms, or other ranges. The useful range depends upon the application. A resistance value of 270 Ohms may be particularly useful to function in place of a probe tip resistor. As an alternative to controlling the amount of metal flake as a weight percent, other conductive or partially-conductive particles could be used to achieve a resistive formulation. These may include carbon particles, dry ceramic, and carbon nanotubes, as examples.

In one embodiment, the metal flake has a concentration in the range of 70 to 95 weight percent of the conductive adhesive. In addition to controlling the resistance/resistivity, the amount of metal flake may have an impact on the adhesion properties of the acrylic-base adhesive and may need to be adjusted for different applications as more metal flakes may reduce the adhesive properties of the conductive adhesive. In one embodiment, for example, the metal flake has a concentration of 80 weight percent of the conductive adhesive. The metal flakes may comprise one or more of the following metals: silver, copper, gold, titanium, and alloys of silver, copper, gold and titanium.

The acrylic-base adhesive may have a concentration in the range of 5 to 30 weight percent of the conductive adhesive. Again, the concentration of the acrylic-base adhesive within the conductive adhesive may depend upon the application and the materials to which it needs to stick and the electrical characteristics needed. In one embodiment, the acrylic-base adhesive has a concentration of 20% of the conductive adhesive.

As mentioned above, the acrylic-base adhesive may include several components. Examples include acrylate oligomers, (hydroxyethyl) methacrylate, carboxyethyl acrylate, acrylic acid, photoinitiators and catalysts. Acrylate oligomers examples may include urethane and polyester acrylates used in UV curable applications. (Hydroxyethyl) methacrylate, carboxyethyl acrylate and acrylic acid are used in the formation of acrylate polymers and can act as thickening agents.

The photoinitiator begins the cross-linking or polymerization process that results in the acrylic-base adhesive, as well as starting the curing process. Examples include, but are not limited to: hydroxyacetonephenone (HAP), phosphineoxide (TPO), hydrogen peroxide, benzoyl peroxide, nitrogen dioxide, molecular oxygen, azobisisobutyronitrile (AIBN) and any material in the phenone family. Catalysts may be any type of benzoate. A thermal catalyst may be included, such as a thermal catalyst from the peroxy family that ‘finishes’ the curing of the adhesive, mostly using heat to cure the areas or layers of the adhesive that is not reached by the UV light. These are merely examples of the various components, and the components themselves may be substituted as needed for different applications.

Once cured, the conductive adhesive will typically have a hardness is the range of 85 to 95 on the Shore D Hardness Scale that measures the hardness of hard rubbers, semi-rigid plastics and hard plastics. This is contrasted with the Shore A Hardness Scale for flexible mold rubbers, and, at the higher end, semi-rigid plastics. A Shore D Hardness measure of 85 to 95 usually classifies a material in this range as “extra hard.” The hardness ensures that the electrical connection formed by the metal flakes remains both protected and attached to the DUT. As discussed above, the metal flakes form a conductive pathway through the adhesive. This is more than likely due to the randomized geometry of the flakes, having interlocking and stacking features. The randomized geometry flakes are shard-like and therefore more-easily pierce through the acrylic base during the cure process such that the interlocking and stacking features of the flakes interlock and stack with each other to form electrically conductive pathways.

In this manner, a UV-curable, acrylic-base adhesive is provided. It allows better adhesion to metals commonly used in devices under test than epoxy-based adhesives. The electrical performance may be tunable based upon the concentration of the metal flakes to achieve different levels of resistance. Additionally it may have different thicknesses to adjust for different applications.

### EXAMPLES

Illustrative examples of the disclosed technologies are provided below. An embodiment of the technologies may include one or more, and any combination of, the examples described below.

Example 1 is a composition of matter including an ultraviolet (UV) and thermally curable, non-epoxy acrylic adhesive having a concentration in the range of 5 to 30 weight percent of the composition, and conductive metal particles having a concentration in the range of 70 to 95 weight percent of the composition.

Example 2 is the composition of matter of Example 1, wherein the composition of matter has a viscosity in the range of 72,000 to 78,000 centipoise.

Example 3 is the composition of matter of Example 1, wherein the composition of matter has a viscosity in the range of 12,000 to 18,000 centipoise.

Example 4 is the composition of matter of any of the previous Examples, wherein the conductive metal particles comprises one selected from the group consisting of: silver, copper, gold, titanium, and alloys of silver, copper, titanium, and gold.

Example 5 is the composition of matter of any of the previous Examples, wherein the UV curable, non-epoxy acrylic adhesive has a concentration of 20 percent of the composition and the conductive metal particles has a concentration of 80 percent of the composition.

Example 6 is the composition of matter of any of the previous Examples, wherein the composition of matter has a hardness in the range of 85 to 95 on the Shore D hardness scale.

Example 7 is the composition of matter of any of the previous Examples, wherein the acrylic adhesive includes an acrylate oligomer, (hydroxyethyl) methacrylate, carboxyethyl acrylate, acrylic acid, a photoinitiator, and a catalyst.

Example 8 is the composition of matter of any of the previous Examples, wherein the metal particles comprise metal flakes having a randomized geometry of interlocking and stacking features.

Although specific embodiments have been illustrated and described for purposes of illustration, it will be understood that various modifications may be made without departing from the spirit and scope of the disclosure. Accordingly, the invention should not be limited except as by the appended claims.

1. A composition of matter, comprising:
an ultraviolet (UV) and thermally curable, non-epoxy acrylic adhesive having a concentration in the range of 5 to 30 weight percent of the composition; and
conductive metal particles in the range of 70 to 95 weight percent of the composition.

2. The composition of matter of claim 1, wherein the conductive metal particles comprises one selected from the group consisting of: silver, copper, gold, titanium, and alloys of silver, copper, titanium, and gold.

3. The composition of matter of claim 1, wherein the UV and thermally curable, non-epoxy acrylic adhesive has a concentration of 20 percent of the composition and the conductive metal particles has a concentration of 80 percent of the composition.

4. The composition of matter of claim 1, wherein the composition of matter has a viscosity in the range of 12,000 to 18,000 centipoise.

5. The composition of matter of claim 1, wherein the composition of matter has a hardness in the range of 85 to 95 on the Shore D hardness scale.

6. The composition of matter of claim 1, wherein the composition of matter has a viscosity in the range of 72,000 to 78,000 centipoise.

7. The composition of matter of claim 1, wherein the acrylic adhesive includes an acrylate oligomer, (hydroxyethyl) methacrylate, carboxyethyl acrylate, acrylic acid, a photoinitiator, and a thermal catalyst.

8. The composition of matter of claim 1, wherein the metal particles comprise metal flakes having a randomized geometry of interlocking and stacking features.

9. A composition of matter, comprising:
an ultraviolet (UV) and thermally curable, non-epoxy acrylic adhesive having a concentration in the range of 5 to 30 weight percent of the composition; and
conductive metal particles having a concentration in the range of 70 to 95 weight percent of the composition,
wherein the composition of matter has a viscosity in the range of 12,000 to 15,000 centipoise.

10. The composition of matter of claim 9, wherein the conductive metal particles comprises one selected from the group consisting of: silver, copper, gold, titanium, and alloys of silver, copper, titanium, and gold.

11. The composition of matter of claim 9, wherein the UV and thermally curable, non-epoxy acrylic adhesive has a concentration of 20 percent of the composition and the conductive metal particles has a concentration of 80 percent of the composition.

12. The composition of matter of claim 9, wherein the acrylic adhesive includes an acrylate oligomer, (hydroxyethyl) methacrylate, carboxyethyl acrylate, acrylic acid, a photoinitiator, and a catalyst.

13. The composition of matter of claim 9, wherein the composition of matter has a hardness in the range of 85 to 95 on the Shore D hardness scale.

14. The composition of matter of claim 9, wherein the metal particles comprise metal flakes having a randomized geometry of interlocking and stacking features.

15. A composition of matter, comprising:
an ultraviolet (UV) and thermally curable, non-epoxy acrylic adhesive having a concentration in a range of 5 to 30 weight percent of the composition;
conductive metal particles having a concentration in the range of 70 to 95 percent weight percent of the composition; and
wherein the composition of matter has a viscosity in the range of 12,000 to 18,000 centipoise.

16. The composition of matter of claim 15, wherein the conductive metal particles comprises one selected from the group consisting of: silver, copper, gold, titanium, and alloys of silver, copper, titanium, and gold.

17. The composition of matter of claim 15, wherein the UV and thermally curable, non-epoxy acrylic adhesive has a weight percent of 20 percent of the composition and the conductive metal particles has a weight percent of 80 percent of the composition.

18. The composition of matter of claim 15, wherein the acrylic adhesive includes an acrylate oligomer, (hydroxyethyl) methacrylate, carboxyethyl acrylate, acrylic acid, a photoinitiator, and a thermal catalyst.

19. The composition of matter of claim 15, wherein the composition of matter has a hardness in the range of 85 to 95 on the Shore D hardness scale.

20. The composition of matter of claim 15, wherein the metal particles comprise metal flakes having a randomized geometry of interlocking and stacking features.
